(19) United States
(12) Patent Application Publication
(10) Pub. No.: US 2011/0109818 A1
(43) Pub. Date: May 12, 2011

(54) Liquid crystal display device, method for manufacturing the same, and projection-type liquid crystal display apparatus with liquid crystal display device

(75) Inventors: Naoki Uneda, Kumamoto (JP); Yoshihiro Mizuguchi, Kumamoto (JP); Moriyasu Nagura, Kumamoto (JP); Masahiro Kaida, Kagoshima (JP); Shinya A. Inage, Kumamoto (JP); Yoshinori Ogino, Kumamoto (JP)

(73) Assignee: Sony Corporation, Tokyo (JP)

(21) Appl. No.: 12/923,543

(22) Filed: Sep. 28, 2010

(30) Foreign Application Priority Data
Nov. 6, 2009 (JP) 2009-255202
Jan. 25, 2010 (JP) 2010-012807

(51) Int. Cl. G02F 1/1335; H01J 9/20

(52) U.S. Cl. 349/5; 349/95; 445/24

(57) ABSTRACT

A method for manufacturing a liquid crystal display device includes: an active matrix substrate formation step of forming an active matrix substrate, wherein the active matrix substrate formation step includes a first step of forming a microlens array having a plurality of microlenses on a transparent substrate, a second step of forming an oxide film on the microlens array, a third step of forming a TFT array having a plurality of TFT devices above the oxide film, and a fourth step of forming a light-blocking film selectively to define pixel openings.

### BACKGROUND OF THE INVENTION

1. Field of the Invention

The present invention relates to a liquid crystal display device with microlenses formed therein, a method for manufacturing the liquid crystal display device, and a projection-type liquid crystal display apparatus with the liquid crystal display device.

2. Description of the Related Art

In recent years, projection-type liquid crystal display apparatus (liquid crystal projectors) in which a liquid crystal display device is incorporated have been actively developed. Projection-type liquid crystal display apparatus are classified in terms of functionality and form into, for example, data projectors for personal computers, front projectors for home theaters, and rear projectors for rear-projector televisions.

Projection-type liquid crystal display apparatus are also broadly categorized into a single-plate type using one liquid crystal display device having R (red), G (green), and B (blue) three color sub-pixels provided in each dot and a three-plate type using a monochrome liquid crystal display device in each of the R, G, and B optical paths. Projection-type liquid crystal display apparatus are classified in still another way into transmissive projectors and reflective projectors in accordance with whether the liquid crystal display device, which is the heart of the apparatus, is transmissive or reflective.

It is desired to enhance the brightness, image quality, resolution, and other performance of a projection-type liquid crystal display apparatus and reduce the price thereof, and improvement in the amount of projected light is particularly desired.

The amount of projected light indicates the visibility of a projected image, and one of the factors that determine the amount of projected light is a liquid crystal display device, which serves to spatially modulate the light emitted from a light source in accordance with an image signal and output the modulated image. The light modulated by the liquid crystal display device is projected through a projection lens on a screen, a wall, or any other suitable projection surface and forms an image on the projection surface.

In the liquid crystal display device, a thin film transistor (hereinafter referred to as a “TFT device”) and other components for driving each pixel are formed on a substrate. A light-blocking region called a black matrix is provided between adjacent pixels. The opening ratio of the liquid crystal display device is therefore not 100%.

To increase the opening ratio of the liquid crystal display device, a microlens is disposed for each dot (each pixel or sub-pixel) on a substrate disposed on the light incident-side in the optical axis direction. In this way, an effective opening ratio of the liquid crystal display device is skillfully increased. The “effective opening ratio” of the liquid crystal display device is a ratio of the whole light flux that exits from the liquid crystal display device to the whole light flux incident thereon. In a projection-type liquid crystal display apparatus, the effective opening ratio of the liquid crystal display device is typically calculated by considering not only light loss in the liquid crystal display device itself but also vignetting in a downstream projection lens.

As described above, a microlens provided on the substrate disposed on the light incident side reduces light loss due to the black matrix, which blocks part of the incident light. On the other hand, focusing the light by the microlens disadvantageously increases the degree of divergence of the exiting light and hence causes the vignetting in the downstream projection lens. The increase in the degree of divergence of the exiting light also forces the projection lens to have a small f-number, which, for example, leads to an increase in cost and a decrease in imaging performance.

To address the problem, a liquid crystal display device with another microlens provided downstream of each of the microlenses disposed on the light incident side has been developed.

For example, JP-A-2009-63888 discloses a liquid crystal display device with microlenses disposed on the light exiting side and parallelizing the divergent light having passed through microlenses disposed on the light incident side. The microlenses provided on the light exiting side cancel the divergence of the exiting light focused by the microlenses on the light incident side or reduces the degree of divergence of the exiting light, whereby the effective opening ratio is improved.

### SUMMARY OF THE INVENTION

In the liquid crystal display device with the microlenses provided on the light incident side and the microlenses provided on the light exiting side described above, the light exiting-side microlenses are formed in front of the TFT devices or behind the TFT devices in an active matrix substrate disposed on the light exiting side. That is, the TFT devices are formed after the microlenses are formed in the former configuration (see FIG. 22), whereas the second microlenses are formed after the TFT devices are formed (see FIG. 23).

In a liquid crystal display device in which microlenses and TFT devices are sequentially formed on a transparent substrate, a high refractive index film on each of the microlenses is damaged in a high-temperature annealing process performed in the step of forming the TFT devices, resulting in cracking in the high refractive index film or separation thereof.

It is therefore desirable to provide a liquid crystal display device in which a high refractive index film on each microlens formed in an active matrix substrate will not be damaged. It is also desirable to provide a method for manufacturing the liquid crystal display device and a projection-type liquid crystal display apparatus.

According to a first embodiment of the invention, there is provided a method for manufacturing a liquid crystal display device. The method includes an active matrix substrate formation step of forming an active matrix substrate, and the active matrix substrate formation step includes a first step of forming a microlens array having a plurality of microlenses on a transparent substrate, a second step of forming an oxide film on the microlens array, a third step of forming a TFT array having a plurality of TFT devices above the oxide film, and a fourth step of forming a light-blocking film selectively to define pixel openings.

According to a second embodiment of the invention, in the first step in the method for manufacturing a liquid crystal display device according to the first embodiment, the microlenses are arranged two-dimensionally in such a way that adjacent microlenses are disposed with a predetermined spacing therebetween.

According to a third embodiment of the invention, in the method for manufacturing a liquid crystal display device according to the second embodiment, the spacing between adjacent microlenses is smaller than or equal to the narrowest value of the widths of the light-blocking film between the adjacent microlenses.

According to a fourth embodiment of the invention, in the first step in the method for manufacturing a liquid crystal display device according to the second or third embodiment; the microlenses are formed in such a way that an effective radius r of each of the microlenses satisfies L≦r≦p/√2, where p represents the spacing between pixels and L represents the largest value of the distances from the center of gravity of the corresponding pixel opening to the edge thereof.

According to a fifth embodiment of the invention, the method for manufacturing a liquid crystal display device according to any one of the second to fourth embodiments further includes a counter substrate formation step of forming a counter substrate that faces the active matrix substrate with a liquid crystal layer therebetween, and the counter substrate formation step includes the step of forming a plurality of second microlenses disposed in such a way that the second microlenses are disposed in the focal positions of the microlenses and vice versa.

According to a sixth embodiment of the invention, in the method for manufacturing a liquid crystal display device according to any one of the second to fourth embodiments, the first step includes the steps of forming lens surface shapes of the microlenses on the transparent substrate, forming a separating layer region for isolating adjacent ones of the microlenses on the transparent substrate in a boundary region between adjacent ones of the lens surface shapes, and filling the space between the separating layer regions with a lens material.

According to a seventh embodiment of the invention, there is provided a liquid crystal display device including a liquid crystal layer, an active matrix substrate, and a counter substrate that faces the active matrix substrate with the liquid crystal layer therebetween. The active matrix substrate includes a transparent substrate, a microlens array having a plurality of microlenses formed on the transparent substrate, an oxide film formed on the microlens array, a TFT array having a plurality of TFT devices formed above the oxide film, and a light-blocking film that defines a plurality of two-dimensionally arranged pixel openings through which light can pass.

According to an eighth embodiment of the invention, in the liquid crystal display device according to the seventh embodiment, the microlenses are arranged two-dimensionally in such a way that adjacent microlenses are disposed with a spacing therebetween.

According to a ninth embodiment of the invention, in the liquid crystal display device according to the eighth embodiment, the spacing between adjacent microlenses is smaller than or equal to the narrowest value of the widths of the light-blocking film between the adjacent microlenses.

According to a tenth embodiment of the invention, in the liquid crystal display device according to the eighth or ninth embodiment, the microlenses are formed in such a way that an effective radius r of each of the microlenses satisfies L≦r≧p/√2, where p represents the spacing between pixels and L represents the largest value of the distances from the center of gravity of the corresponding pixel opening to the edge thereof.

According to an eleventh embodiment of the invention, in the liquid crystal display device according to any one of the eighth to tenth embodiments, the counter substrate has a second microlens array in which a plurality of second microlenses are arranged two-dimensionally in correspondence with the plurality of pixel openings, and the microlenses in the active matrix substrate and the second microlenses in the counter substrate are disposed in such a way that the microlenses are disposed in the focal positions of the second microlenses and vice versa.

According to a twelfth embodiment of the invention, there is provided a projection-type liquid crystal display apparatus including a light source that emits light, a liquid crystal display device that optically modulates the light emitted from the light source, and a projection lens that projects the light modulated by the liquid crystal display device. The liquid crystal display device includes a liquid crystal layer, an active matrix substrate, and a counter substrate that faces the active matrix substrate with the liquid crystal layer therebetween. The active matrix substrate includes a transparent substrate, a microlens array having a plurality of microlenses formed on the transparent substrate, an oxide film formed on the microlens array, a TFT array having a plurality of TFT devices formed above the oxide film, and a light-blocking film that defines a plurality of two-dimensionally arranged pixel openings through which light can pass.

According to a thirteenth embodiment of the invention, in the projection-type liquid crystal display apparatus according to the twelfth embodiment, the microlenses are arranged two-dimensionally in such a way that adjacent microlenses are disposed with a spacing therebetween.

According to the embodiments of the invention, since the oxide film is formed on the high refractive index film of the microlenses formed on the active matrix substrate, damage to the high refractive index film of the microlenses can be suppressed.

### BRIEF DESCRIPTION OF THE DRAWINGS

FIG. 1 shows an exemplary overall configuration of a projection-type liquid crystal display apparatus according to an embodiment of the invention;

FIG. 2 shows an exemplary schematic configuration of a liquid crystal display device according to an embodiment of the invention;

FIG. 3 shows another exemplary schematic configuration of the liquid crystal display device according to the embodiment of the invention;

FIG. 4 shows another exemplary schematic configuration of the liquid crystal display device according to the embodiment of the invention;

FIG. 5 diagrammatically shows the angular intensity distribution of the light that exits from a liquid crystal display device of related art using only first microlenses;

FIG. 6 diagrammatically shows the angular intensity distribution of the light that exits from the liquid crystal display device according to the embodiment of the invention;

FIG. 7 shows results of TDS (hydrogen) in a high temperature annealing process in the configuration of a liquid crystal display device of related art;

FIG. 8 shows the relationship between the presence/absence of ammonia in a CVD film deposition process and damage after high-temperature annealing;

FIG. 9 shows damage to a high refractive index film of second microlenses;

FIGS. 10A and 10B shows damage to the high refractive index film of the second microlenses;

FIGS. 11A and 11B shows damage to the high refractive index film of the second microlenses;

FIG. 12 shows the light intensity distribution of a light spot focused by a first microlens;

FIG. 13 shows the relationship among an effective size of the second microlenses, a pixel spacing, and a pixel opening;

FIG. 14 shows the relationship among the effective size of the second microlenses, the pixel spacing, and the pixel opening;

FIG. 15 shows the relationship among the effective size of the second microlenses, the pixel spacing, and the pixel opening;

FIG. 16 shows the relationship among the effective size of the second microlenses, the pixel spacing, and the pixel opening;

FIG. 17A shows a step of manufacturing the liquid crystal display device according to the embodiment of the invention;

FIG. 17B shows a step of manufacturing the liquid crystal display device according to the embodiment of the invention;

FIG. 17C shows a step of manufacturing the liquid crystal display device according to the embodiment of the invention;

FIG. 17D shows a step of manufacturing the liquid crystal display device according to the embodiment of the invention;

FIG. 17E shows a step of manufacturing the liquid crystal display device according to the embodiment of the invention;

FIG. 17F shows a step of manufacturing the liquid crystal display device according to the embodiment of the invention;

FIG. 17G shows a step of manufacturing the liquid crystal display device according to the embodiment of the invention;

FIG. 17H shows a step of manufacturing the liquid crystal display device according to the embodiment of the invention;

FIG. 18A shows another step of manufacturing the liquid crystal display device according to the embodiment of the invention;

FIG. 18B shows another step of manufacturing the liquid crystal display device according to the embodiment of the invention;

FIG. 18C shows another step of manufacturing the liquid crystal display device according to the embodiment of the invention;

FIG. 19 shows cracking triggered by voids;

FIG. 20A shows another step of manufacturing the liquid crystal display device according to the embodiment of the invention;

FIG. 20B shows another step of manufacturing the liquid crystal display device according to the embodiment of the invention;

FIG. 20C shows another step of manufacturing the liquid crystal display device according to the embodiment of the invention;

FIG. 20D shows another step of manufacturing the liquid crystal display device according to the embodiment of the invention;

FIG. 20E shows another step of manufacturing the liquid crystal display device according to the embodiment of the invention;

FIG. 20F shows another step of manufacturing the liquid crystal display device according to the embodiment of the invention;

FIG. 20G shows another step of manufacturing the liquid crystal display device according to the embodiment of the invention;

FIG. 20H shows another step of manufacturing the liquid crystal display device according to the embodiment of the invention;

FIG. 21 shows the configuration of a liquid crystal display device according to another embodiment of the invention;

FIG. 22 shows the configuration of a liquid crystal display device of related art; and

FIG. 23 shows the configuration of another liquid crystal display device of related art.

### DESCRIPTION OF THE PREFERRED EMBODIMENTS

A projection-type liquid crystal display apparatus according to an embodiment of the invention includes a light source that emits light, a liquid crystal display device that optically modulates the light emitted from the light source, and a projection lens that projects the light modulated by the liquid crystal display device.

The liquid crystal display device includes a liquid crystal layer, an active matrix substrate, and a counter substrate that faces the active matrix substrate with the liquid crystal layer therebetween.

The active matrix substrate includes a transparent substrate, a microlens array having a plurality of microlenses formed on the transparent substrate, and a TFT array having a plurality of TFT devices formed above the microlens array. The active matrix substrate further includes a light-blocking film that defines a plurality of two-dimensionally arranged pixel openings through which light can pass.

The microlens array is formed of a low refractive index film (low refractive index layer) and a high refractive index film (SiON film or SiN film, for example), and an oxide film is formed on the high refractive index film. Examples of the oxide film may include a SiO₂ film, an Al₂O₃ film, a TiO₂ film, a ZrO₂ film, a HfO₂ film, a Ta₂O₅ film, a RuO₂ film, and an IrO₂ film.

The oxide film formed on the high refractive index film of the microlens array can suppress damage to the high refractive index film of the microlenses due to annealing for forming a gate oxide film of each of the TFT devices.

The microlenses are arranged two-dimensionally with a spacing between adjacent microlenses. This arrangement can further suppress the damage to the high refractive index film of the microlenses.

A detailed description will be made of a liquid crystal display device, a method for manufacturing the liquid crystal display device, and a projection-type liquid crystal display apparatus with the liquid crystal display device according to an embodiment of the invention with reference to the drawings.

The description will be made in the following order.

1. Overall configuration of projection-type liquid crystal display apparatus

2. Configuration of liquid crystal display device

3. Measures taken to suppress damage to second microlenses

4. Method for manufacturing liquid crystal display device

5. Variation of method for manufacturing liquid crystal display device

6. Other embodiments

### 1. Overall Configuration of Projection-Type Liquid Crystal Display Apparatus

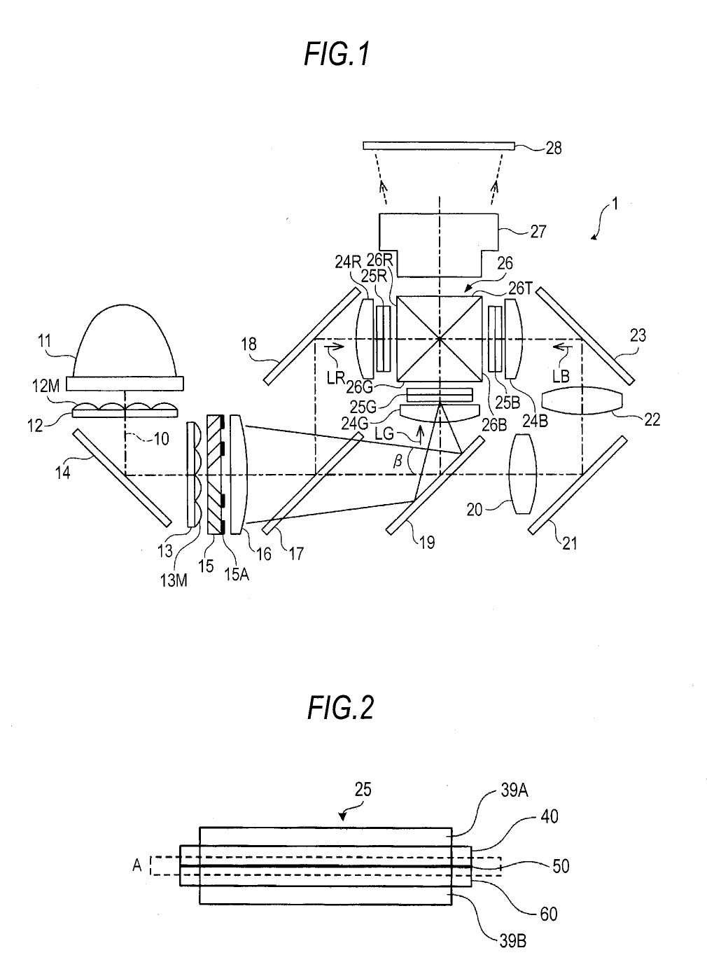

FIG. 1 shows an exemplary overall configuration of a projection-type liquid crystal display apparatus according to an embodiment of the invention. The projection-type liquid crystal display apparatus shown in FIG. 1 is what is called a three-panel projection-type liquid crystal display apparatus using three transmissive liquid crystal display devices to display a color image. As shown in FIG. 1, the projection-type liquid crystal display apparatus 1 according to the present embodiment includes a light source 11 that emits light, a pair of fly's eye lenses, a first fly's eye lens 12 and a second fly's eye lens 13, and a total-reflection mirror 14 that is disposed between the fly's eye lenses 12 and 13 and deflects the optical path (optical axis 10) by approximately 90 degrees toward the second fly's eye lens 13.

The light source 11 emits white light containing red light, blue light, and green light, which are necessary to display a color image. The light source 11 is formed of a light emitter (not shown) that emits white light and a concave mirror that reflects the light emitted from the light emitter. The light emitter is, for example, a halogen lamp, a metal halide lamp, or a xenon lamp. The concave mirror is formed of an ellipsoidal mirror, a paraboloidal mirror, or a mirror having any other suitable rotationally symmetric surface.

The first and second fly's eye lenses 12, 13 are formed of a plurality of two-dimensionally arranged microlenses 12M and 13M. Each of the first and second fly's eye lenses 12, 13 homogenizes the illuminance distribution of the light incident thereon and has a function of dividing the incident light into a plurality of sub-light fluxes. The white light emitted from the light source 11 is therefore divided into a plurality of sub-light fluxes when passing through the first and second fly's eye lenses 12, 13.

The projection-type liquid crystal display apparatus 1 further includes a PS combining element 15, a condenser lens 16, and a dichroic mirror 17 disposed in this order on the light exiting side of the second fly's eye lenses 13.

The light having passed through the first and second fly's eye lenses 12, 13 is incident on the PS combining element 15. The PS combining element 15 has a plurality of half-wave plates 15A disposed in the positions corresponding to the boundaries between adjacent ones of the microlenses in the second fly's eye lens 13. The PS combining element 15 separates the incident light into a first polarized light flux (P-polarized component) and a second polarized light flux (S-polarized component) and outputs one of the polarized light fluxes (P-polarized component, for example) with its polarization direction maintained through the PS combining element 15 whereas outputting the other polarized light flux (S-polarized component, for example) after the half-wave plates 15A convert it into the polarized light flux having the other polarization component (P-polarized component, for example). The polarization directions of the two separated polarized light fluxes are thus aligned with each other in a specific direction (P-polarized direction, for example).

The light having exited through the PS combining element 15 passes through the condenser lens 16 and then enters the dichroic mirror 17. The dichroic mirror 17 separates the light incident thereon into red light LR and light having the other colors.

The projection-type liquid crystal display apparatus 1 further includes a total reflection mirror 18, a field lens 24R, and a liquid crystal display device 25R disposed in this order along the optical path of the red light LR, which has been separated by the dichroic mirror 17. The total reflection mirror 18 reflects the red light LR separated by the dichroic mirror 17 toward the liquid crystal display device 25R. The red light LR reflected off the total reflection mirror 18 is incident on the liquid crystal display device 25R via the field lens 24R. The red light LR incident on the liquid crystal display device 25R is spatially modulated therein in accordance with an image signal and then incident on an incident surface 26R of a cross prism 26, which will be described later.

The projection-type liquid crystal display apparatus 1 further includes a dichroic mirror 19 disposed in the optical path of the light having the other colors, which has been separated by the dichroic mirror 17. The dichroic mirror 19 separates the light incident thereon into green light LG and blue light LB. The projection-type liquid crystal display apparatus 1 further includes a field lens 24G and a liquid crystal display device 25G disposed in this order along the optical path of the green light LG separated by the dichroic mirror 19. The green light LG is incident on the liquid crystal display device 25G via the field lens 24G. The green light LG incident on the liquid crystal display device 25G is spatially modulated therein in accordance with an image signal and then incident on an incident surface 26G of the cross prism 26, which will be described later.

The projection-type liquid crystal display apparatus 1 further includes a relay lens 20, a total reflection mirror 21, a relay lens 22, a total reflection mirror 23, a field lens 24B, and a liquid crystal display device 25B disposed in this order along the optical path of the blue light LB separated by the dichroic mirror 19. The total reflection mirror 21 reflects the blue light LB incident thereon via the relay lens 20 toward the total reflection mirror 23. The total reflection mirror 23 reflects the blue light LB incident thereon via the relay lens 22 toward the liquid crystal display device 25B. The liquid crystal display device 25B spatially modulates the blue light LB incident thereon via the field lens 24B in accordance with an image signal and then directs the modulated light toward an incident surface 26B of the cross prism 26, which will be described later.

The plurality of sub-light fluxes divided by the first and second fly's eye lenses 12, 13 are enlarged and superimposed on incident surfaces of the liquid crystal display devices 25R, 25G, and 25B, and generally uniform illumination is achieved over the incident surfaces. Each of the sub-light fluxes divided by the first and second fly's eye lenses 12, 13 is enlarged at a magnification determined by the focal length of the condenser lens 16 and the focal length of the microlenses 13M provided in the second fly's eye lens 13.

Although not shown, incident light polarizers through which polarized light is incident on the liquid crystal display devices 25R, 25G, and 25B are provided on the light exiting side of the field lenses 24R, 24G, and 24B, and exiting light polarizers that control the light modulated by the liquid crystal display devices are provided on the light incident surfaces 26R, 26G, and 26B of the cross prism 26.

The projection-type liquid crystal display apparatus 1 further includes the cross prism 26, which is disposed in the position where the optical paths of the red light LR, the green light LG, and the blue light LB intersect, and the cross prism 26 combines the three color light fluxes LR, LG, and LB. The projection-type liquid crystal display apparatus 1 further includes a projection lens 27 for projecting the combined light having exited from the cross prism 26 toward a screen 28. An image is formed on the screen 28 when the light having exited from the cross prism 26 is projected through the projection lens 27 on the front or rear side of the screen 28. The cross prism 26 has three light incident surfaces 26R, 26G, and 26B and one light exiting surface 26T. The red light LR, the green light LG, and the blue light LB having exited from the respective liquid crystal display devices 25R, 25G, and 25B are incident on the respective light incident surfaces 26R, 26G, and 26B. The cross prism 26 then combines the three color light fluxes incident on the light incident surfaces 26R, 26G, and 26B and outputs the combined light through the light exiting surface 26T.

### 2. Configuration of Liquid Crystal Display Device

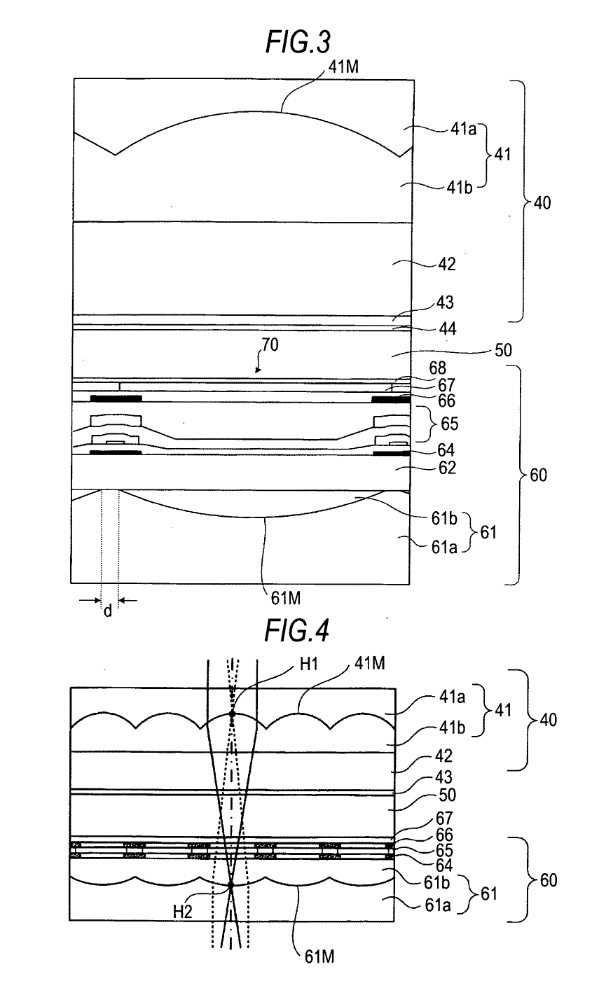

FIGS. 2 and 3 show an exemplary configuration of the liquid crystal display devices 25R, 25G, and 25B. FIG. 3 is an enlarged view of the portion A shown in FIG. 2. The liquid crystal display devices 25R, 25G, and 25B only differ from one another in terms of the light component to be modulated but have substantially the same functionality and configuration. The configuration of the liquid crystal display devices 25R, 25G, and 25B for the respective colors will be collectively described below.

As shown in FIG. 2, the liquid crystal display device 25 (25R, 25G, and 25B) includes an anti-dust glass plate 39A, a counter substrate 40, a liquid crystal layer 50, an active matrix substrate 60, and an anti-dust glass plate 39B disposed in this order along the light incident direction.

The counter substrate 40 is formed of a first microlens array 41 (second microlens array), a cover layer 42, a counter electrode 43 formed of a transparent electrode, and an orientation film 44 in this order along the light incident direction, as shown in FIG. 3. The counter electrode 43 generates a potential between the counter electrode 43 and pixel electrodes 67, which will be described later.

The first microlens array 41 is formed of a low refractive index optical material layer 41a and a high refractive index optical material layer 41b sequentially formed on the light incident side and has a plurality of first microlenses 41M (second microlenses) provided two-dimensionally in correspondence with the pixel electrodes 67, which will be described later. Each of the first microlenses 41M has positive refracting power as a whole. In the example shown in FIG. 3, the lens surface of each of the first microlenses 41M has a spherical shape that is convex toward the light incident side (light source side). To allow each of the first microlenses 41M having the surface profile described above to have positive refracting power, the refractive index n1 of the low refractive index optical material layer 41a and the refractive index n2 of the high refractive index optical material layer 41b satisfy “n2>n1.” The difference in refractive index between n2 and n1, for example, ranges from approximately 0.2 to 0.3 but is desirably higher. The optical material layers 41a and 41b are made, for example, of a urethane-based or acrylic resin.

The f-number of each of the first microlenses 41M is set to be greater than or equal to the f-number of the, downstream projection lens 27. Therefore, most of the light incident on the liquid crystal display device 25, focused by the first microlenses 41M, and incident on pixel openings 70, which will be described later, is effective light that can be used to display an image.

The active matrix substrate 60 is formed by sequentially forming a second microlens array 61, an oxide film 62, an interlayer insulating film 63, a rear-side light-blocking film 64, TFT devices 65, a front-side light-blocking film 66, pixel electrodes 67, each of which is formed of a transparent electrode, an orientation film 68, and other components. The rear-side light-blocking film 64 and the front-side light-blocking film 66 form an effective black matrix. Openings which are surrounded by the black matrix and through which incident light can pass form the pixel openings 70, each of which corresponds to a single pixel (dot). The TFT devices 65 for applying voltages selectively to the respective adjacent pixel electrodes 67 in accordance with an image signal are formed in the black matrix.

The second microlens array 61 is formed of a transparent substrate 61a, which is a low refractive index optical material layer, and a high refractive index film 61b and has a plurality of second microlenses 61M provided two-dimensionally in correspondence with the pixel electrodes 67. Each of the second microlenses 61M has positive refracting power as a whole. In the example shown in FIG. 3, the lens surface of each of the second microlenses 61M has a spherical shape that is convex toward the light exiting side (facing away from the light source side). To allow each of the second microlenses 61M having the surface profile described above to have positive refracting power, the refractive index n3 of the transparent substrate 61a and the refractive index n4 of the high refractive index film 61b satisfy “n4>n3.” The difference in refractive index between n3 and n4, for example, ranges from approximately 0.2 to 0.3 but is desirably higher. The transparent substrate 61a and the high refractive index film 61b are made, for example, of a urethane-based or acrylic resin.

As described above, in the liquid crystal display device 25 according to the present embodiment, each dot has two microlenses, that is, the corresponding first microlens 41M and second microlens 61M, are disposed along the optical axis direction.

The first microlenses 41M and the second microlenses 61M are disposed in such a way that the former is disposed in the focal position of the latter and vice versa. That is, the focal position of each of the first microlenses 41M coincides with a principal point H2 of the corresponding second microlens 61M (see FIG. 4), and the focal position of each of the second microlenses 61M coincides with a principal point H1 of the corresponding first microlens 41M (see FIG. 4). That is, the first microlenses 41M and the second microlenses 61M are disposed in such a way that the former is disposed in the focal position of the latter and vice versa.

The configuration described above prevents the exiting light from diverging and allows the angle of divergence β (see FIG. 1) of incident illumination light to be increased, whereby the light can be used more efficiently. Further, the f-number of the first microlenses 41M can be set at a small value down to the f-number of the projection lens 27. The focal length of the first microlenses 41M therefore does not need to be long in consideration of the vignetting in the projection lens 27, whereby the amount of vignetting in the black matrix can be reduced. Further, since the second microlenses 61M are disposed on the light exiting side, the f-number thereof can be a large value, whereby manufacturing variation can be suppressed.

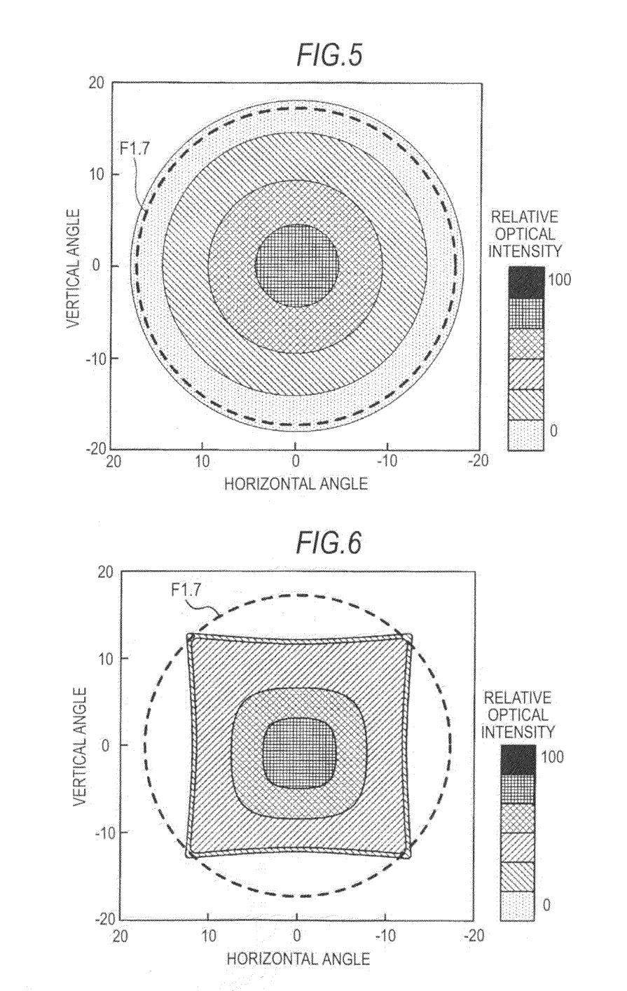

FIG. 5 shows the angular intensity distribution of the light that exits from a liquid crystal display device of related art using only the first microlenses 41M, and FIG. 6 shows the angular intensity distribution of the light that exits from the liquid crystal display device 25 according to the present embodiment. FIGS. 5 and 6 show simulation results under the condition that the angle of divergence of the illumination light is 12 degrees and the pixel spacing is 8.4 μm (opening ratio of 55%).

FIGS. 5 and 6 show that the divergence of the light in the projection-type liquid crystal display apparatus 1 according to the present embodiment is generally smaller than that in the projection-type liquid crystal display apparatus of related art. When the f-number of the projection lens is 1.7 and the conditions described above remain the same, the amount of projected light from the projection-type liquid crystal display apparatus 1 according to the present embodiment is 10% higher than that from the projection-type liquid crystal display apparatus of related art. Since the angle of divergence of the exiting light is small as described above, the f-number of the projection lens 27 can be larger than a value in related art while the amount of projected light in related art is maintained. In this case, the cost of the projection lens 27 can also be reduced. For example, using the liquid crystal display device 25 of the present embodiment in the example described above allows the f-number of the projection lens 27 to be increased from 1.7 to 2.0 while the amount of projected light in related art is maintained.

Each of the first microlenses 41M forms a light focusing lens having a light focusing capability and improves the proportion of the illumination light passing through the corresponding pixel opening 70 and incident on the liquid crystal display device 25. Each of the second microlenses 61M forms a field lens having a fielding capability. The opening efficiency seems to be higher when the focal position of the first microlenses 41M is located in the vicinity of the pixel openings 70, but the configuration in which the pixel openings 70 perfectly coincide with the focal position of the first microlenses 41M does not give the highest opening efficiency in consideration of all angular components of the incident light. The pixel openings 70 are desirably disposed in the beam waist position of the light in consideration of all angular components.

The first and second microlenses 41M, 61M do not necessarily have the illustrated shapes as long as they have positive refracting power and predetermined optical characteristics. For example, each of the microlenses may have a spherical surface, an aspheric surface, a Fresnel surface, or a combination of any two of them.

### 3. Measures Taken to Suppress Damage to Second Microlenses 61M

The TFT devices 65 for the projection-type liquid crystal display apparatus 1 are made of high-temperature polysilicon, and the temperature in the process of forming a gate oxide film of each of the TFT devices 65 ranges from 600 to 1000°. In consideration of this fact, the second microlenses 61M are formed of a high refractive index film made of an inorganic material, such as a silicon oxynitride film (SiON) and a silicon nitride film (SiN), which withstand a high temperature process.

As described above, when the TFT devices are formed on the second microlenses in the active matrix substrate, the high refractive index film made of an inorganic material greatly expands due to thermal stress induced in a high temperature annealing process performed in the step of forming the gate oxide films of the TFT devices. The expansion causes film separation, cracking, and other damage to the high refractive index film of the microlenses in the active matrix substrate.

The degree of expansion increases in proportion to the process temperature. When the TFT devices are formed at a lower temperature in order to prevent cracking and film separation in the microlenses in the active matrix substrate, however, satisfactory gate oxide films or TFT characteristics are not achieved.

To address the problem, the liquid crystal display device 25 according to the present embodiment is configured as follows to suppress damage to the second microlenses 61M in the active matrix substrate.

(A) The oxide film 62 (see FIG. 3) is formed on the second microlenses 61M.

(B) The second microlenses 61M are formed with a spacing d therebetween (see FIG. 3).

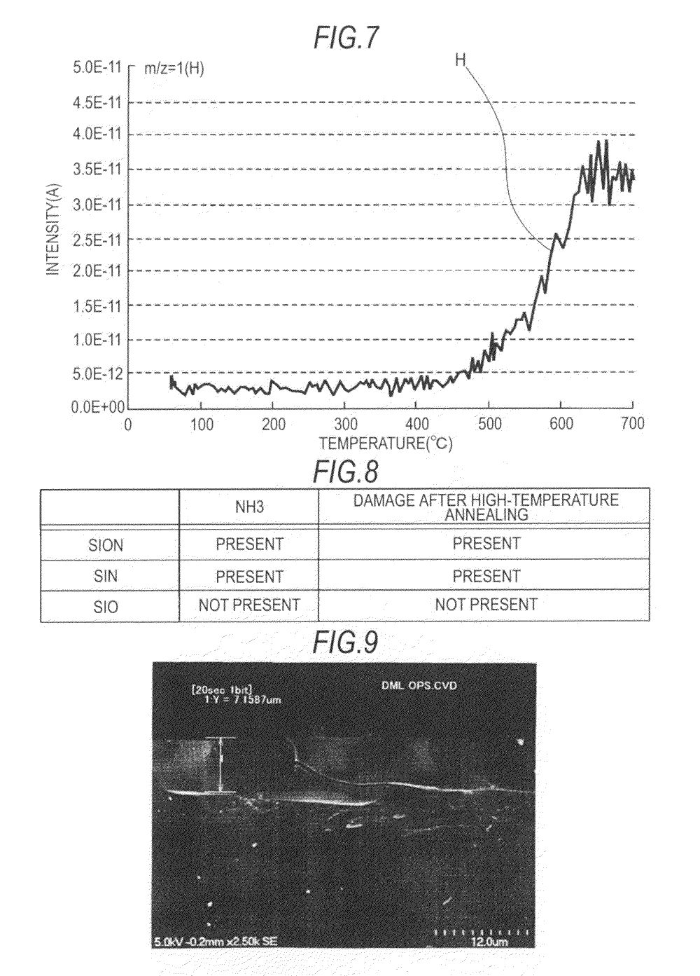

The item (A) is first described. The present inventors have conducted TDS (Thermal Desorption Spectroscopy) on hydrogen in the high temperature annealing process for forming the gate oxide films of the TFT devices in the configuration of the liquid crystal display device of related art (see FIG. 22). FIG. 7 shows results of the TDS. FIG. 7 shows that hydrogen (H) desorbs when the annealing temperature was approximately 500° C.

As shown in FIG. 8, ammonia (NH₃) containing hydrogen (H) is necessary to form the high refractive index film, such as a silicon oxynitride film (SiON) and a silicon nitride film (SiN), in a CVD film deposition process. On the other hand, ammonia is not necessary to form the low refractive index film, such as a silicon oxide film (SiO₂), in a CVD film deposition process.

It is speculated from the results described above that the film damage in the high-temperature annealing process is caused by the desorption of hydrogen (H). In consideration of this fact, an experiment was carried out in such a way that a silicon oxide film (SiO₂) or any other suitable oxide film was deposited on the high refractive index film, and then high temperature annealing was carried out to anneal the gate oxide films of the TFT devices. The experiment demonstrated that the film damage due to the high temperature annealing was reduced. It was particularly demonstrated that the film damage was further reduced by increasing in-plane compressive stress in the silicon oxide film (SiO₂) on the high refractive index film.

When the configuration described in (B) is achieved by separating the high refractive index film, voids produced in the CVD film deposition process may cause cracking, as shown in FIG. 9, even with a silicon oxide film (SiO₂) deposited on the high refractive index film. It is therefore desirable to reduce the number of voids as much as possible. To this end, the silicon oxide film (SiO₂) is desirably formed by using a CVD apparatus based on HDP (High Density Plasma) or any other suitable technique.

The item (B) is next described. A plurality of liquid crystal display devices are formed on a wafer and then separated into individual devices. In the case of the liquid crystal display device of related art, the high refractive index film of the second microlenses is formed on the entire surface of the wafer, as shown in FIG. 10A, and cracking occurs in the high refractive index film, as shown in FIG. 10B.

The present inventors conducted an experiment in which the TFT devices were formed after the high refractive index film of the second microlenses was separated into each of the liquid crystal display devices, as shown in FIG. 11A. The experiment demonstrated that cracking occurred in the high refractive index film not so differently from the case where the high refractive index film was formed on the entire surface of the wafer, as shown in FIG. 11B.

Thereafter, the present inventors conducted an experiment in which the TFT devices were formed after the second microlenses were formed with a spacing therebetween. That is, the TFT devices were formed after the high refractive index film was separated by a groove having a predetermined width d (hereinafter also referred to as a “separating groove”), as shown in FIG. 3. The experiment demonstrated that the occurrence of cracking in the high refractive index film was greatly reduced. A conceivable reason for this is that forming the separating groove at the boundary between adjacent microlenses limits the influence of expansion and deformation of the material of the microlenses due to high-temperature thermal stress within the area of a single pixel.

On the other hand, when the separation width d increases, the effective size of each of the second microlenses 61M becomes insufficient, resulting in a decrease in the amount of light that passes through the liquid crystal display device 25 and a decrease in the effective opening ratio.

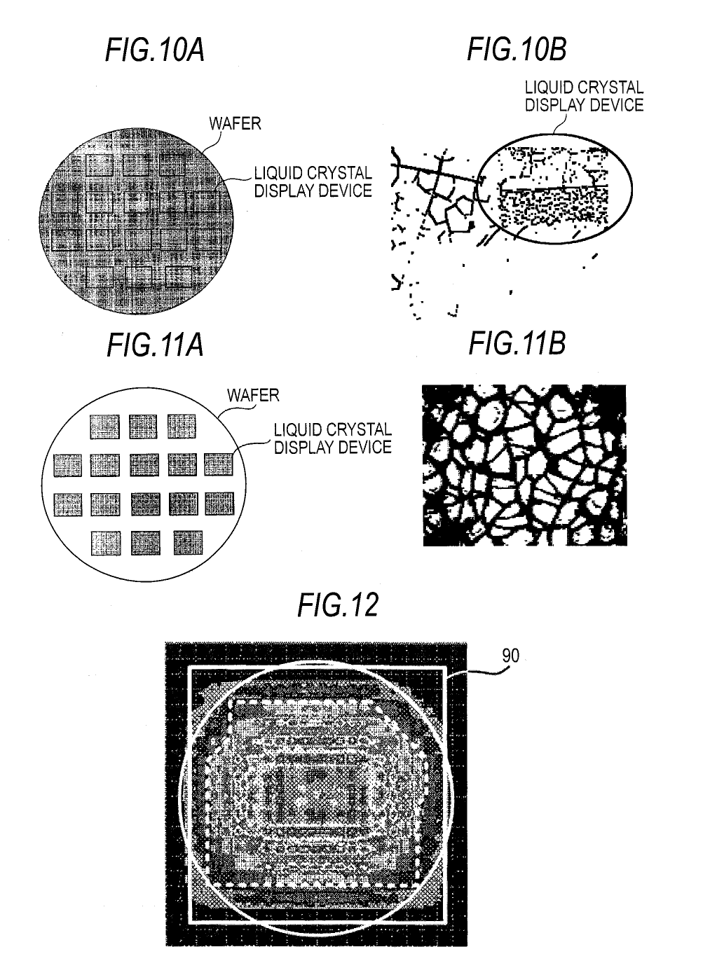

FIG. 12 shows the light intensity distribution of a light spot focused on the active matrix substrate 60 by one of the first microlenses 41M. In FIG. 12, the solid-line rectangular frame represents the size of the corresponding pixel 90; the dotted-line frame represents the corresponding pixel opening 70; and the solid-line circular frame represents the effective size of the corresponding second microlens 61M. It is noted that the effective area of the second microlens 61M is the area within the rectangular frame.

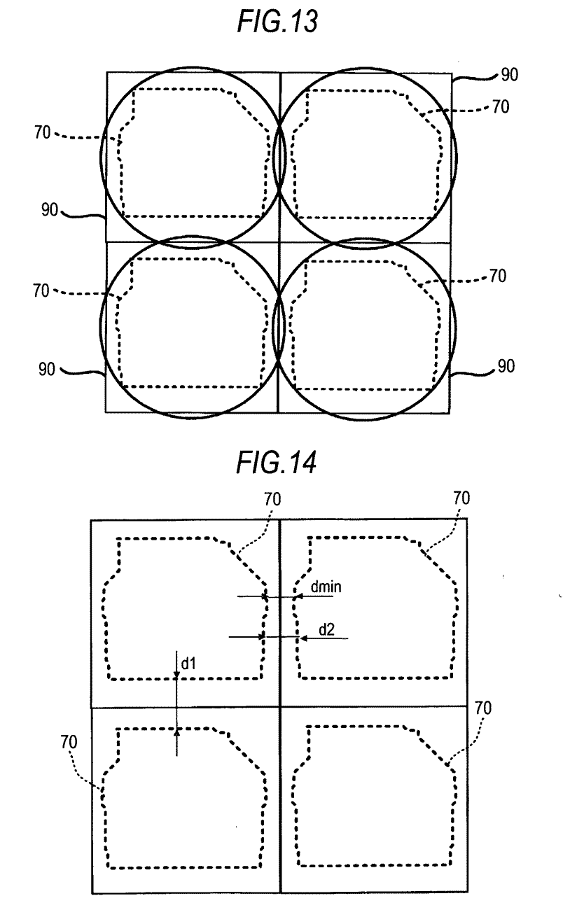

Since the pixels 90 are arranged adjacent to each other, as shown in FIG. 13, there are the following characteristics.

(1) The effective area of each of the second microlenses 61M decreases as the separation width d between the second microlenses 61M increases, and the amount of light passing through the corresponding pixel 90 decreases accordingly.

(2) The effective diameter of each of the second microlenses 61M decreases as the separation width d between the second microlenses 61M increases, and the amount of light passing through of the corresponding pixel opening 70 and hence the corresponding pixel 90 decreases accordingly.

To minimize the light loss due to the reasons described in (1) and (2), it is necessary to effectively set the separation width d between the second microlenses 61M and the effective radius r of each of the second microlenses 61M.

A description will first be made of how to set the separation width d between the second microlenses 61M. To reduce the light loss, the separation width d between the second microlenses 61M needs to satisfy the following equation:

0≦d≦dmin

where dmin represents the smallest value of vertical and horizontal spacings {d1, d2, . . . } (see FIG. 14) between adjacent pixel openings 70.

The separation width d between the second microlenses 61M is set to be smaller than or equal to the smallest spacing between adjacent pixel openings 70, as described above. That is, the spacing between the second microlenses 61M is set to be smaller than or equal to the smallest width of the light-blocking films 64 and 66 between adjacent second microlenses 61M. In this way, the decrease in the effective area of each of the second microlenses 61M can be suppressed as small as possible, and the light loss can be minimized.

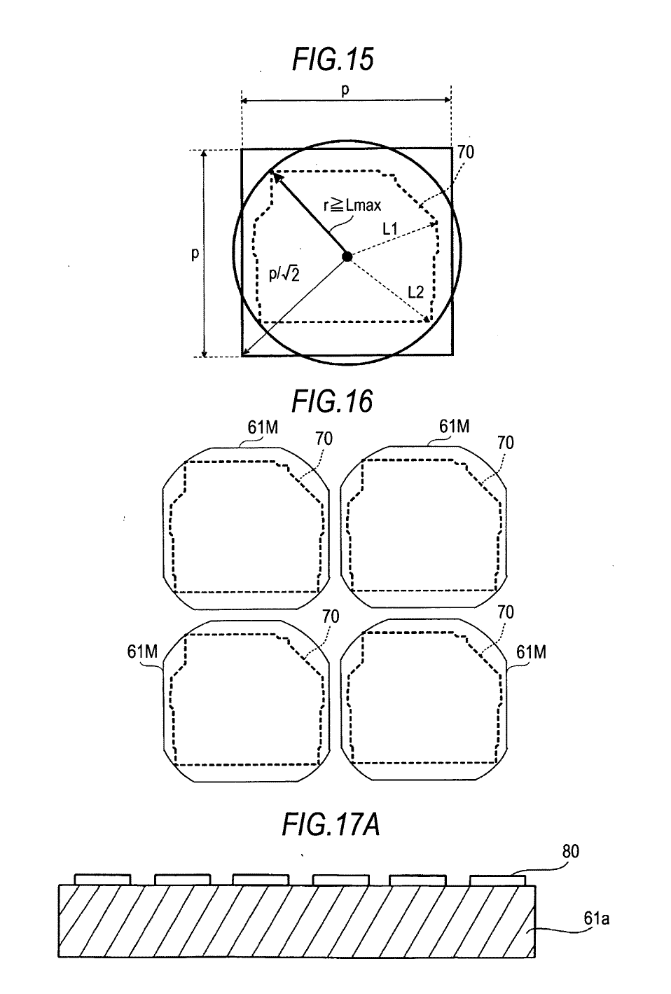

A description will next be made of how to set the effective radius r between the second microlenses 61M. As shown in FIG. 15, the effective radius r of each of the second microlenses 61M for suppressing the light loss needs to satisfy the following equation:

Lmax≦r≦p/√2

where p represents the pixel spacing and Lmax represents the largest value of the distances {L1, L2, . . . } from the center of gravity of any of the pixel openings 70 to the edge thereof.

That is, the effective radius r of each of the second microlenses 61M needs to be greater than or equal to the smallest size that can cover the entire shape of the corresponding pixel opening 70 but smaller than or equal to the diagonal radius p/√2, which is determined by the pixel spacing p. The light transmittance can be increased by forming the second microlenses 61M that are larger than or equal to the pixel openings 70, as described above.

FIG. 16 shows the shape of the second microlenses 61M that satisfies the two conditions described above. In FIG. 16, the dotted-line frames represent the pixel openings 70, and the solid-line frames represent the effective size of the second microlenses 61M.

As shown in FIG. 16, adjacent second microlenses 61M are separated from each other. The effective size of each of the second microlenses 61M has a shape obtained by truncating a circle into a rectangle, and only the four corners thereof have the effective radius r. In this configuration, the separation width d and the effective radius r satisfy the condition that the size of each of the second microlenses 61M covers the entire shape of the corresponding pixel opening 70, whereby the transmitted light loss due to insufficiency of the area of each of the second microlenses 61M can be minimized.

### 4. Method for Manufacturing Liquid Crystal Display Device

A method for manufacturing the liquid crystal display device 25 will next be described with reference to the drawings. The method for manufacturing the liquid crystal display device 25 includes the steps of forming the active matrix substrate 60, forming the counter substrate 40, and stacking the counter substrate 40 on the active matrix substrate 60 with the liquid crystal layer 50 therebetween. The step of forming the counter substrate 40 includes the step of forming the first microlenses 41M (second microlenses) disposed in such a way that the first microlenses 41M are disposed in the focal positions of the second microlenses 61M and vice versa.

One feature of the method for manufacturing the liquid crystal display device 25 according to the present embodiment resides in the active matrix substrate formation step of forming the active matrix substrate 60. That is, the active matrix substrate formation step includes a first step of forming the second microlens array 61 having a plurality of second microlenses 61M on the transparent substrate 61a, a second step of forming the oxide film 62 on the second microlens array 61, a third step of forming the TFT array having a plurality of TFT devices 65 above the oxide film 62, and a fourth step of forming the rear-side light-blocking film 64, the front-side light-blocking film 66, and other light-blocking films selectively to define the pixel openings 70. The active matrix substrate formation step will be specifically described below.

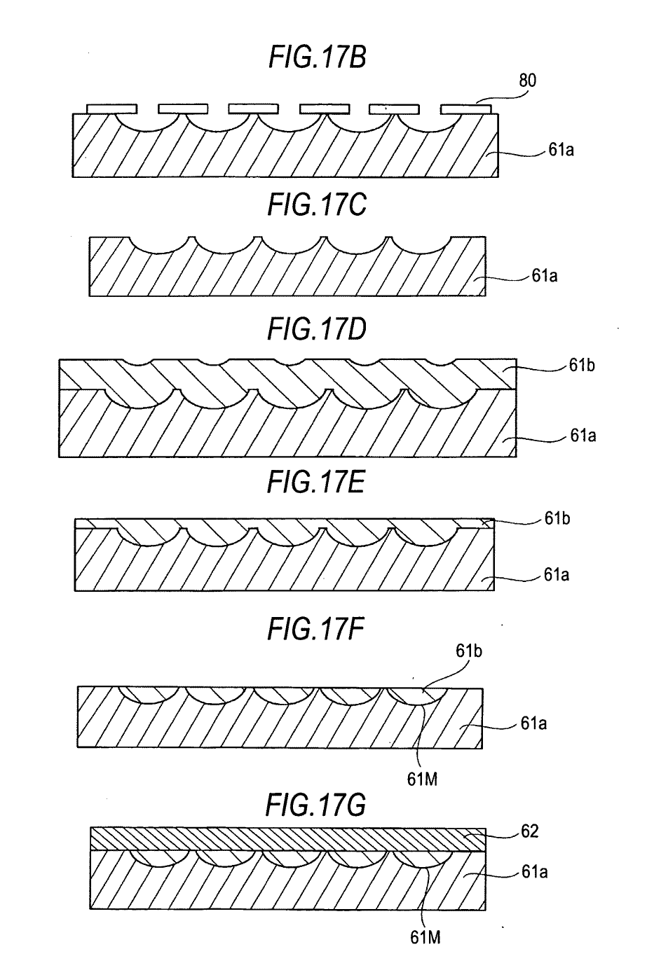

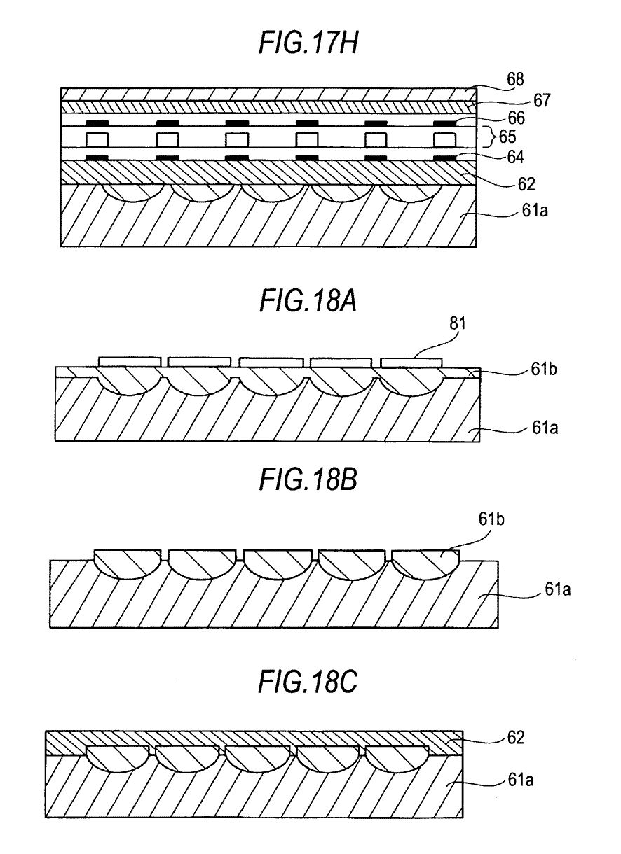

The transparent substrate 61a, such as a quartz glass substrate, is first prepared, and a resist pattern 80 for forming the second microlenses 61M is then formed, as shown in FIG. 17A.

Isotropic etching is then carried out by injecting a chemical solution through the holes formed in the resist pattern 80 to form the shapes of the second microlenses 61M, as shown in FIG. 17B. Examples of the chemical solution may include a glass etchant containing an inorganic acid, a fluoride, or an alkali metal hydride. The resist pattern 80, which is now unnecessary, is removed by using an ashing apparatus, as shown in FIG. 17C.

The high refractive index film 61b is then formed on the transparent substrate 61a, which now has the shapes of the second microlenses 61M, as shown in FIG. 17D. Examples of the high refractive index film 61b may include a silicon oxynitride film (SiON) and a silicon nitride film (SiN). The high refractive index film 61b is deposited, for example, in a plasma CVD process at a low temperature of approximately 400° C.

Thereafter, CMP (Chemical Mechanical Polishing) is carried out to polish and planarize the surface of the high refractive index film 61b, as shown in FIG. 17E. CMP is subsequently performed again to polish the surface to separate the high refractive index film 61b for each of the pixels 90, as shown in FIG. 17F. As a result, adjacent second microlenses 61M are disposed with a predetermined spacing therebetween. CMP may be replaced with an etching back technique.

The oxide film 62 is then deposited on the second microlenses 61M, as shown in FIG. 17G. An example of the oxide film 62 is a silicon oxide film (SiO₂).

The rear-side light-blocking film 64, the TFT devices 65, the front-side light-blocking film 66, the pixel electrodes 67, the orientation film 68, and other components are sequentially stacked, as shown in FIG. 17H. Although not shown, the interlayer insulating film 63, a variety of wiring liens, and other components are also formed. To form the gate oxide films (not shown) of the TFT devices 65, annealing is carried out at a temperature ranging from 600 to 1000° C.

As described above, in the method for manufacturing the active matrix substrate 60 according to the present embodiment, the second microlens array 61 having a plurality of second microlenses 61M is formed on the transparent substrate 61a, and the oxide film 62 is then formed on the second microlens array 61. Therefore, even when the TFT array having a plurality of TFT devices 65 is then formed in an annealing process, damage due to the annealing to the second microlenses 61M can be reduced. Further, since adjacent second microlenses 61M are disposed with a predetermined spacing therebetween, stress induced in the high refractive index film 61b can be suppressed even when the high refractive index film 61b expands. Damage due to the expansion to the second microlenses 61M can therefore be further reduced.

The high refractive index film 61b is separated into pixels by polishing the surface thereof in a CMP process in the example described above, but the separating method is not limited to CMP.

For example, after the high refractive index film 61b is planarized in the CMP process, as shown in FIG. 17E, a resist pattern 81 is formed to separate the high refractive index film 61b into pixels, as shown in FIG. 18A. Anisotropic etching is then carried out by injecting a chemical solution through the holes formed in the resist pattern 81 to form the shapes of the second microlenses 61M, and the resist pattern 81, which is now unnecessary, is removed by using an ashing apparatus, as shown in FIG. 18B.

The oxide film 62 is then formed on the transparent substrate 61a, on which the second microlenses 61M have been formed, as shown in FIG. 18C. Thereafter, the components starting from the interlayer insulating film 63 are sequentially formed until the orientation film 68 is formed, as having been shown in FIG. 17H. The active matrix substrate 60 is thus formed.

### 5. Variation of Method for Manufacturing Liquid Crystal Display Device

A variation of the method for manufacturing the liquid crystal display device 25 will next be described. That is, the embodiment described above prevents film damage in the downstream high-temperature annealing process by forming the second microlenses 61M with the spacing d therebetween (see FIG. 3).

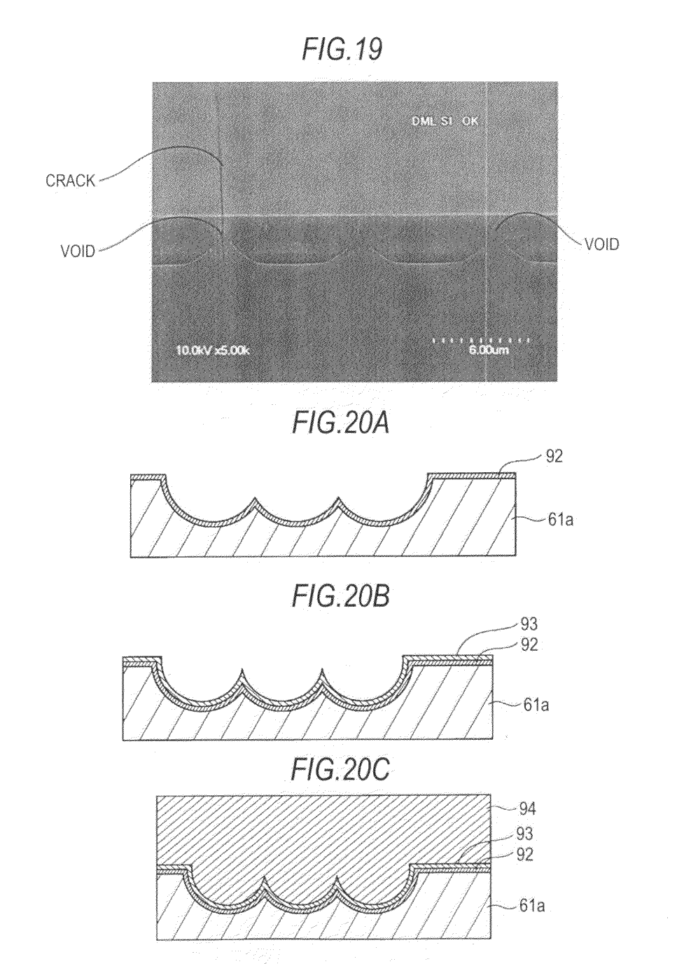

Although separating the high refractive index film 61b certainly suppresses an increase in the magnitude of the stress induced in the high-temperature annealing process, it has been known that when the interlayer insulating film 63 is deposited, for example, in a CVD process on the grooves produced in the separation process, voids are produced depending on the film deposition coverage and the voids can trigger cracking. FIG. 19 describes a state in which voids have caused cracking.

To prevent the voids from being produced, the first step of forming the second microlens array 61 in the active matrix substrate formation step in the procedure of manufacturing the liquid crystal display device 25 is changed in the present variation.

That is, the first step in the variation includes the steps of forming the lens surface shape of each of the second microlenses 61M on the transparent substrate 61a, forming a separating layer region for isolating adjacent second microlenses 61M from each other in a boundary region between adjacent ones of the lens surface shapes, and filling the space between the separating layer regions with a lens material.

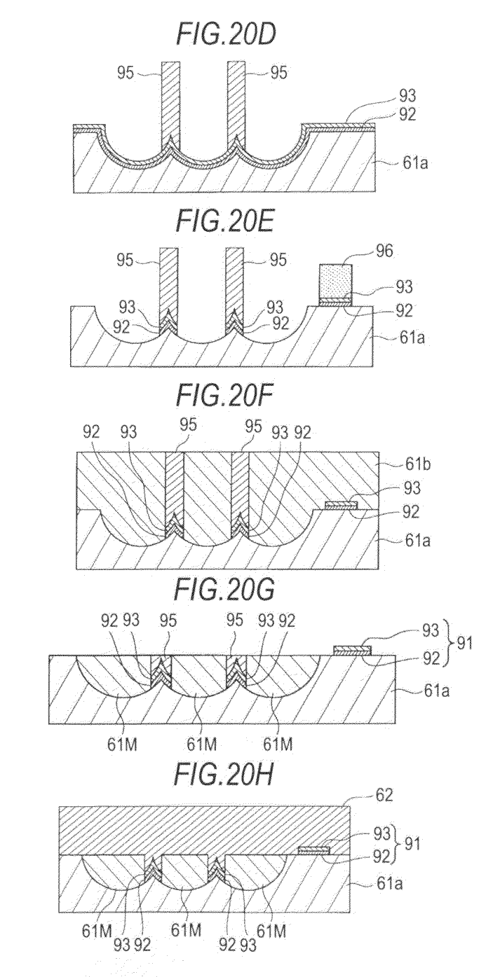

In particular, one feature of the variation resides in the separating layer region formation step, in which the separating layer regions having a column shape are formed by using a silicon oxide film (SiO₂), whose property is the same as that of the oxide film 62 deposited on the high refractive index film 61b formed, for example, of a silicon oxynitride film (SiON) or a silicon nitride film (SiN), which is a lens material. A method for manufacturing the liquid crystal display device 25 according to the variation will be specifically described with reference to FIGS. 17A to 17C and FIGS. 20A to 20H.

In the following description, alignment marks 91 (see FIG. 20H) having high reflectance and stable visibility even when undergoing planarization in a CMP (Chemical Mechanical-Polishing) or etching process are simultaneously formed. The alignment marks 91 may be formed in a known method in the art. Any method may be used in the following description as long as a plurality of column-shaped separating layer regions is formed and the space between the separating layer regions is filled with the lens material to form the second microlens array 61.

The steps in an upstream stage in the present variation are the same as those in the method described with reference to the above embodiment. The transparent substrate 61a, such as a quartz glass substrate, is first prepared, and the resist pattern 80 for forming the second microlenses 61M is then formed, as shown in FIG. 17A.

Isotropic etching is then carried out by injecting a chemical solution through the holes formed in the resist pattern 80 to form the shapes of the second microlenses 61M, as shown in FIG. 17B. Examples of the chemical solution may include a glass etchant containing an inorganic acid, a fluoride, or an alkali metal hydride. The resist pattern 80, which is now unnecessary, is removed by using an ashing apparatus, as shown in FIG. 17C.

A PDAS (Phosphorus Doped Amorphous Silicon) film 92 is then deposited, for example, in a CVD process on the transparent substrate 61a, which now has the shapes of the second microlenses 61M. The PDAS film 92 is provided to aid formation of the alignment marks 91 (see FIG. 20H) made of WSi (tungsten silicide) and having high reflectance and makes a WSi film 93, which will be then formed on the PDAS film 92, more stably adhere thereto than in a case where the WSi film 93 is directly deposited on the transparent substrate 61a.

The WSi film 93, which will form the alignment marks 91, is then deposited on the PDAS film 92 having been deposited, for example, in a sputtering film deposition process or a CVD process using tungsten as a source gas, as shown in FIG. 20B. The WSi film 93 also functions as an etching stopper.

A P—SiO film 94, whose property is the same as that of the oxide film 62 (silicon oxide film) to be formed on the high refractive index film 61b, which is the lens material in a downstream step, is deposited to a predetermined thickness, as shown in FIG. 20C. To form the P—SiO film 94 having a predetermined thickness, plasma vapor deposition is carried out in a plasma CVD process.

Thereafter, to form the separating layer region for isolating adjacent second microlenses 61M from each other in a boundary region between adjacent ones of the lens surface shapes, a mask (not shown) is placed on the P—SiO film 94, and anisotropic dry etching is carried out to form column-shaped separating portions 95. The vertically elongated, column-shaped separating portions 95, which form the separating layer regions, are thus formed in the boundary regions between the lens surface shapes, as shown in FIG. 20D. In this process, the WSi film 93 functions as an etching stopper, whereby only the P—SiO film 94 is etched but the lens shapes remain intact.

Thereafter, a mask 96 is placed in a position where the alignment marks 91 are formed, and the exposed PDAS film 92 and WSi film 93 are removed, for example, in an etching process, as shown in FIG. 20E.

The space between the separating layer regions formed of the column-shaped separating portions 95 is then filled with a silicon oxynitride film (SiON) or a silicon nitride film (SiN), which is the lens material, to form the high refractive index film 61b on the transparent substrate 61a, as shown in FIG. 20F. The high refractive index film 61b can be deposited, for example, in a plasma CVD process at a low temperature of approximately 400° C.

Thereafter, the column-shaped separating portions 95 and the high refractive index film 61b are planarized in a CMP-based (Chemical Mechanical Polishing) surface polishing process or an etching back process. The high refractive index film 61b is thus separated by the column-shaped separating portions 95 for each of the pixels 90, as shown in FIG. 20G. As described above, the present variation also allows adjacent second microlenses 61M to be disposed with a predetermined spacing therebetween.

The oxide film 62 made of SiO₂ is deposited on the second microlenses 61M, as shown in FIG. 20H. Since the oxide film 62 and the column-shaped separating portions 95 are made of the same material, they are integrated with each other, as shown in FIG. 20H. Further, since the oxide film 62 is formed on the planarized surface, as shown in FIG. 20G, voids will not be produced, unlike the related art in which the film deposition is carried out on the surface with the high-aspect-ratio separating grooves for reducing the stress induced in the plurality of second microlenses 61M.

The following steps are the same as those in the method described in the above embodiment. That is, the rear-side light-blocking film 64, the TFT devices 65, the front-side light-blocking film 66, the pixel electrodes 67, the orientation film 68, and other components are sequentially stacked, as shown in FIG. 17H. Although not shown, the interlayer insulating film 63, a variety of wiring liens, and other components are also formed. To form the gate oxide films (not shown) of the TFT devices 65, annealing is carried out at a temperature ranging from 600 to 1000° C.

As described above, the method for manufacturing the active matrix substrate 60 in the method for manufacturing the liquid crystal display device 25 according to the variation includes the steps of forming the lens surface shape of each of the second microlenses 61M on the transparent substrate 61a, forming the column-shaped separating portion 95 (separating layer region) for isolating adjacent second microlenses 61M from each other in the boundary region between adjacent ones of the lens surface shapes on the transparent substrate 61a, and filling the space between the separating layer regions with the lens material.

The variation can therefore not only reduce damage to the second microlenses 61M in the following annealing process, as in the embodiment described above, but also prevent voids from being produced. It is therefore possible to effectively prevent substrate cracking due to film stress induced in the high refractive index film 61b.

Further, in the variation described above, in the procedure of manufacturing the active matrix substrate 60, the WSi film 93, which is a metal film that functions as an etching stopper when the column-shaped separating portions 95 are formed, is used to simultaneously form the alignment marks 91 necessary for the downstream steps. Moreover, since each of the alignment marks 91 is not formed of a stepped portion of a groove but uses high reflectance unlike related art, the visibility of the marks will not deteriorate after a CMP- or etching-based planarization process.

### 6. Other Embodiments

The above embodiment has been described with reference to the projection-type liquid crystal display apparatus using three liquid crystal display devices, which is the most typical form. A single-plate, color projection-type liquid crystal display apparatus can also provide the same advantageous effect.

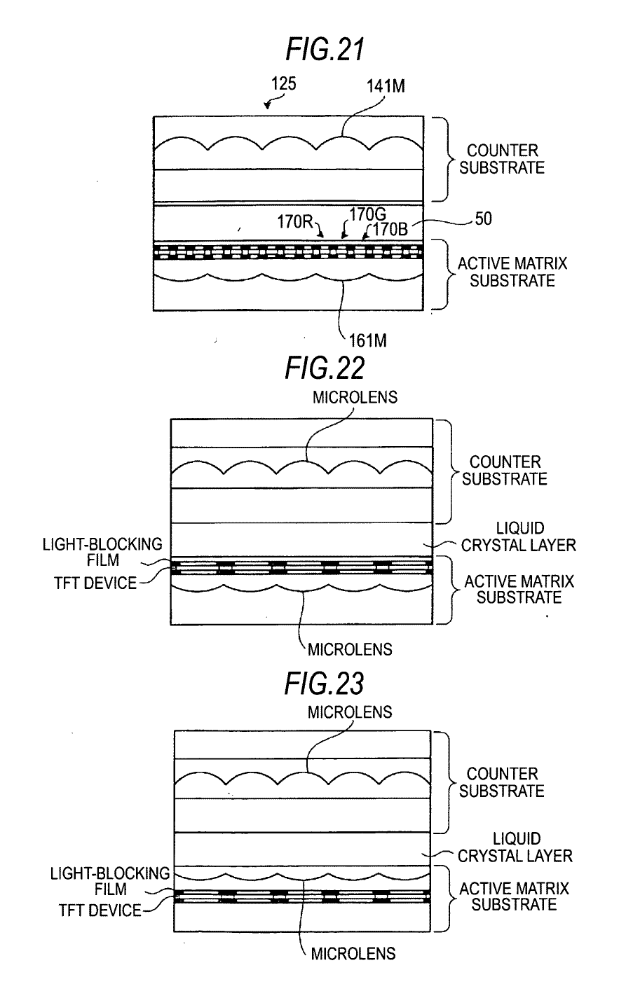

In a single-plate, color projection-type liquid crystal display apparatus 1, a liquid crystal display device 125 optically modulates the red light LR, the green light LG, and the blue light LB incident thereon in accordance with image signals and outputs the modulated light toward the following projection lens. The color light fluxes incident at different angles are directed toward the respective pixels through a first microlens array 141M (see FIG. 21) provided in the liquid crystal display device 125. A color image is obtained by using the liquid crystal to control the light transmittance of each of the pixels (see JP-A-4-60538 for a basic principle).

The liquid crystal display device 125 has the same configuration as that of the liquid crystal display device 25 described above except that pixel openings 170R, 170G, and 170B and TFT devices for the R, G, and B colors are formed on a pixel basis as shown in FIG. 21. The same components as those of the liquid crystal display device 25 have the same reference characters, and no specific description of the same components will be made.

As described above, in the liquid crystal display device 125 having the same configuration as that of the liquid crystal display device 25, the second microlenses 61M cancel divergence of the illuminated light, which is the same advantageous effect as that provided by the liquid crystal display device 25, and the divergence of the red light LR and the blue light LB can also be reduced. A projection-type liquid crystal display apparatus that can project a large amount of light having excellent white balance can thus be achieved.

Further, the principal ray of the red light LR and the principal ray of the blue light LB are made parallel to the principal ray of the green light LG by the second microlenses 161M. For example, consider a case where the divergence angle of the illumination light is ±3° in the horizontal direction and ±7° in the vertical direction; the angles of the principle rays are 8° for the blue light, 0° for the green light, and −8° for the red light; and the f-number of a projection lens 127 is 1.7. Performing a simulation under the conditions described above shows that an advantageous effect on the amount of projected light increases by a factor of 1.216 for blue and red and a factor of 1.033 for green as compared with those obtained in the configuration of related art using only the first microlens array. Since the green light LG generally has small divergence and the angles of the principal rays of the blue light LB and the red light LR are corrected by the second microlenses 161M, the advantageous effect described above is further enhanced.

Embodiments of the invention have been described above in detail with reference to the drawings, but the embodiments are presented by way of example. The invention can be implemented in other forms to which a variety of changes and modifications are made based on the knowledge of the skilled in the art.

The present application contains subject matter related to those disclosed in Japanese Priority Patent Applications JP 2009-255202 and JP 2010-012807 filed in the Japan Patent Office on Nov. 6, 2009 and Jan. 25, 2010, respectively, the entire contents of which is hereby incorporated by reference.

1. A method for manufacturing a liquid crystal display device, the method comprising:
an active matrix substrate formation step of forming an active matrix substrate,
wherein the active matrix substrate formation step includes
a first step of forming a microlens array having a plurality of microlenses on a transparent substrate,
a second step of forming an oxide film on the microlens array,
a third step of forming a TFT array having a plurality of TFT devices above the oxide film, and
a fourth step of forming a light-blocking film selectively to define pixel openings.

2. The method for manufacturing a liquid crystal display device according to claim 1,
wherein in the first step, the microlenses are arranged two-dimensionally in such a way that adjacent microlenses are disposed with a predetermined spacing therebetween.

3. The method for manufacturing a liquid crystal display device according to claim 2,
wherein the spacing between adjacent microlenses is smaller than or equal to the narrowest value of the widths of the light-blocking film between the adjacent microlenses.

4. The method for manufacturing a liquid crystal display device according to claim 2,
wherein in the first step, the microlenses are formed in such a way that an effective radius r of each of the microlenses satisfies
L≦r≦p/√2
where p represents the spacing between pixels and L represents the largest value of the distances from the center of gravity of the corresponding pixel opening to the edge thereof.

5. The method for manufacturing a liquid crystal display device according to claim 2, further comprising:
a counter substrate formation step of forming a counter substrate that faces the active matrix substrate with a liquid crystal layer therebetween,
wherein the counter substrate formation step includes the step of forming a plurality of second microlenses disposed in such a way that the second microlenses are disposed in the focal positions of the microlenses and vice versa.

6. The method for manufacturing a liquid crystal display device according to claim 2,
wherein the first step includes the steps of
forming lens surface shapes of the microlenses on the transparent substrate,
forming a separating layer region for isolating adjacent ones of the microlenses on the transparent substrate in a boundary region between adjacent ones of the lens surface shapes, and
filling the space between the separating layer regions with a lens material.

7. A liquid crystal display device comprising:
a liquid crystal layer;
an active matrix substrate; and
a counter substrate that faces the active matrix substrate with the liquid crystal layer therebetween,
wherein the active matrix substrate includes
a transparent substrate,
a microlens array having a plurality of microlenses formed on the transparent substrate,
an oxide film formed on the microlens array,
a TFT array having a plurality of TFT devices formed above the oxide film, and
a light-blocking film that defines a plurality of two-dimensionally arranged pixel openings through which light can pass.

8. The liquid crystal display device according to claim 7,
wherein the microlenses are arranged two-dimensionally in such a way that adjacent microlenses are disposed with a spacing therebetween.

9. The liquid crystal display device according to claim 8,
wherein the spacing between adjacent microlenses is smaller than or equal to the narrowest value of the widths of the light-blocking film between the adjacent microlenses.

10. The liquid crystal display device according to claim 8,
wherein the microlenses are formed in such a way that an effective radius r of each of the microlenses satisfies
L≦r≦p/√2
where p represents the spacing between pixels and L represents the largest value of the distances from the center of gravity of the corresponding pixel opening to the edge thereof.

11. The liquid crystal display device according to claim 8,
wherein the counter substrate has a second microlens array in which a plurality of second microlenses are arranged two-dimensionally in correspondence with the plurality of pixel openings, and
the microlenses in the active matrix substrate and the second microlenses in the counter substrate are disposed in such a way that the microlenses are disposed in the focal positions of the second microlenses and vice versa.

12. A projection-type liquid crystal display apparatus comprising:
a light source that emits light;
a liquid crystal display device that optically modulates the light emitted from the light source; and
a projection lens that projects the light modulated by the liquid crystal display device,
wherein the liquid crystal display device includes
a liquid crystal layer,
an active matrix substrate, and
a counter substrate that faces the active matrix substrate with the liquid crystal layer therebetween, and
the active matrix substrate includes
a transparent substrate,
a microlens array having a plurality of microlenses formed on the transparent substrate,
an oxide film formed on the microlens array,
a TFT array having a plurality of TFT devices formed above the oxide film, and
a light-blocking film that defines a plurality of two-dimensionally arranged pixel openings through which light can pass.

13. The projection-type liquid crystal display apparatus according to claim 12,
wherein the microlenses are arranged two-dimensionally in such a way that adjacent microlenses are disposed with a spacing therebetween.
